(19) United States
(12) Patent Application Publication
(10) Pub. No.: US 2026/0198523 A1
(43) Pub. Date: Jul. 16, 2026

(54) WET-TEXTURED PLANT PROTEINS

(71) Applicant: ROQUETTE FRERES, Lestrem (FR)

(72) Inventors: Anne MATIGNON, LILLE (FR); Anne-Sophie PETITPREZ, LESTREM (FR); Charlotte DLUBAK, ESTAIRES (FR); Cyril DROULEZ, CAMBRIN (FR)

(21) Appl. No.: 19/134,095

(22) PCT Filed: Dec. 1, 2023
(86) PCT No.: PCT/EP2023/025506

§ 371 Date: May 29, 2025

(30) Foreign Application Priority Data
Dec. 2, 2022 (FR) FR2212718

(51) Int. Cl. A23J 3/14; A23J 3/22; A23J 3/26; A23K 10/30; A23L 23/00

(52) U.S. Cl. CPC A23J 3/14; A23J 3/227; A23J 3/26; A23K 10/30; A23L 23/00

(57) ABSTRACT

The invention relates to a method for the wet extrusion of plant proteins with improved fibration of said proteins.

### PRIOR ART

The present invention relates to a method for manufacturing a composition comprising textured plant proteins, preferentially from legumes, even more preferentially from peas, combined with a pea protein isolate whose solubility in water at pH 7 and 20° C. is less than 30%, as well as to said composition comprising textured pea proteins and its industrial uses.

The technique for texturing proteins, especially by extrusion cooking, with the aim of preparing products with a fibrous structure intended for producing meat and fish analogs, has been applied to numerous plant sources.

The extrusion cooking methods for proteins can be separated into two large families by the amount of water used in the method relative to the total weight of material used in the extruder (dry matter+water). When this amount is greater than 30% by weight, this will be referred to as “wet” extrusion cooking, and the products obtained will be more intended for producing finished products for immediate consumption that simulate animal meat, for example, beef steaks or chicken nuggets. When this amount of water is less than 30% by weight, this is then referred to as “dry” extrusion cooking: the products obtained are more intended to be used by food-processing manufacturers, in order to formulate meat substitutes by mixing them with other ingredients. The present invention is part of so-called “wet” extrusion cooking or “wet” extrusion. The terms “extrusion cooking” and “extrusion” are equivalent and designate the same method in that heating occurs during extrusion, which causes cooking and/or denaturation of the product, hence the term “extrusion cooking” sometimes used to designate extrusion.

Historically, the first proteins used for these meat substitute production methods were extracted from soybean and wheat. Soybean subsequently quickly became the main source for this field of applications.

While most of the studies that followed obviously related to soybean proteins, other sources of protein, both animal and plant, have been textured: peanut, sesame, cottonseed, sunflower, corn, wheat proteins, proteins derived from microorganisms, by-products from abattoirs or the fisheries industry.

Legume proteins, such as those derived from pea and faba bean, have also been the subject of work, both in terms of the isolation thereof and in terms of the “wet” extrusion cooking thereof.

Numerous studies have been undertaken on legume proteins, in particular pea proteins, given their particular functional and nutritional properties but also because of their non-genetically-modified nature.

Despite significant research efforts and increasing growth over recent years, the penetration of these products based on textured proteins on the food market is still subject to optimization.

One of the reasons in particular lies in the poor fibration in wet extrusion of legume protein isolates, in particular for pea proteins. Indeed, it should be noted in the thesis “Texturization of pea protein isolates using high moisture extrusion cooking” (Osen, 2017) that the quality of the protein used in feeding the extruder is an essential parameter in this quest to optimize that method, in particular from a texture point of view.

This poorer fibration is also highlighted in patent application CN114946994. The proprietor proposes the addition of glucono-delta-lactone to improve this. While this solution works, the fact remains that an additive is added here, which complicates labeling and regulatory status, and adds to the complexity of the method and the final cost of the resulting product.

It is to the applicant's credit that it has solved the above problems and developed a method incorporating the use of a pea protein isolate whose solubility in water at pH 7 and 20° C. is less than 30%.

This invention will be better understood in the following section which aims to disclose a general description thereof.

### GENERAL DESCRIPTION OF THE PRESENT INVENTION

The present invention relates to a method for producing a plant protein composition comprising the following steps:
1) Providing a powder mixture comprising:
   plant proteins, preferentially legume proteins, preferentially pea proteins,
   and a pea protein isolate, said isolate having a solubility in water at pH 7 and 20° C. of less than 30%,
said mixture having a respective dry weight ratio of plant protein to pea protein isolate ranging from 70/30 to 95/5, preferentially from 75/25 to 95/5, more preferentially from 80/20 to 95/5, even more preferentially from 85/15 to 95/5;
2) Texturizing said mixture obtained in step 1 by wet extrusion cooking.

Preferably, the plant proteins, preferentially leguminous plants, implemented in the method in step 1 according to the invention are selected from the list containing pea or faba bean, even more preferentially pea protein.

Preferably, the wet extrusion cooking of step 2 of the method according to the invention is carried out in a twin-screw extruder.

The present invention also relates to a composition comprising textured legume proteins capable of being obtained by a production method according to the invention

Preferably, the protein content within the composition according to the invention ranges from 60% to 80%, preferentially from 70% to 80% by dry weight relative to the total weight of dry matter of the composition.

Finally, the present invention relates to the use of the composition of textured legume proteins according to the invention as described above in industrial applications such as, for example, the human and animal food industry, industrial pharmaceuticals or cosmetics.

The present invention will be better understood upon reading the following detailed description.

### DETAILED DESCRIPTION OF THE PRESENT INVENTION

The present invention relates to a method for producing a plant protein composition comprising the following steps:
1) Providing a powder mixture comprising:
   plant proteins, preferentially legume proteins, preferentially pea proteins,
   and a pea protein isolate, said isolate having a solubility in water at pH 7 and 20° C. of less than 30%,
said mixture having a respective dry weight ratio of plant protein to pea protein isolate ranging from 70/30 to 95/5, preferentially from 75/25 to 95/5, more preferentially from 80/20 to 95/5, even more preferentially from 85/15 to 95/5;
2) Texturizing said mixture obtained in step 1 by wet extrusion cooking.

According to the invention, the term “powder” refers to any material whose moisture content and particle size make it suitable for feeding to an extruder.

The first step therefore consists in providing a powder mixture comprising plant proteins, preferentially legume proteins, preferentially pea proteins, and a pea protein isolate, said isolate having a solubility in water at pH 7 and 20° C. of less than 30%, said mixture having a respective dry weight ratio of plant proteins/pea protein isolate having a solubility in water at pH 7 and 20° C. of less than 30%, ranging from 70/30 to 95/5, preferentially from 75/25 to 95/5, more preferentially from 80/20 to 95/5, even more preferentially from 85/15 to 95/5.

Said ratio ranging from 70/30 to 95/5, preferentially from 75/25 to 95/5, more preferentially from 80/20 to 95/5, even more preferentially from 85/15 to 95/5, refers to the respective dry weight ratio of plant proteins to pea protein isolate having a solubility in water at pH 7 and 20° C. of less than 30%.

Plant proteins, preferentially legume proteins, preferentially pea proteins, making up part of the powder mixture used in the method according to the invention, can take the form of an isolate or a concentrate. Even more preferably, the plant proteins, preferentially legume proteins, preferentially pea proteins, making up part of the powder mixture used in the method according to the invention, have a solubility in water at pH 7 and 20° C. greater than 30%.

Preferably, the plant proteins, preferentially legume proteins, are selected from the list made up of faba bean protein and pea protein, as well as mixtures thereof. Pea protein is particularly preferred.

The term “leguminous” is considered herein to mean the family of dicotyledonous plants of the order Fabales. This is one of the largest flowering plant families, third after Orchidaceae and Asteraceae in terms of number of species. It contains approximately 765 genera, bringing together more than 19,500 species. Several leguminous plants are important crop plants, including soybean, beans, peas, faba beans, chickpeas, peanuts, cultivated lentils, cultivated alfalfa, various clovers, broad beans, carob and licorice.

The term “pea” is considered here in its broadest accepted use and includes in particular all the varieties of “smooth pea” and “wrinkled pea” and all the mutant varieties of “smooth pea” and “wrinkled pea”, regardless of the uses for which said varieties are usually intended (human food, animal feed and/or other uses).

In a particular embodiment, the plant proteins used within the scope of the invention do not include soybean proteins. In this embodiment, materials rich in soybean proteins are therefore excluded from the invention. This is in particular due to their referential position from a firmness point of view. Thus, in this particular embodiment, when the plant protein composition is a composition of leguminous plants, the composition is not a composition of soybean proteins.

The term “isolate” should be taken to mean a protein composition with a protein content of 70% to 95% by dry weight, preferentially 80% to 90% by dry weight.

It is essential for the invention that the isolate, whose solubility at pH 7 and 20° C. is less than 3%, is of pea botanical origin. Indeed, as will be shown in the examples section, any other botanical source, including rice in particular, does not work.

The solubility of pea protein isolate is measured using the following Test A:

150 g of distilled water are introduced into a 400 ml beaker at 20° C.±2° C. by stirring with a magnetic stirrer bar, and precisely 5 g of plant protein sample to be tested are added. If required, the pH is adjusted to the desired value, that is, 7, with 0.1 N NaOH. The content is supplemented with water to reach 200 g of water. Mixing is carried out for 30 minutes at 1000 rpm and centrifugation is carried out for 15 minutes at 3000 g. 25 g of the supernatant are collected and introduced into a crystallizing dish dried and tared beforehand. The crystallizing dish is placed in an oven at 103° C.±2° C. for 1 hour. It is then placed in a desiccator (with desiccant) to cool to ambient temperature, and is weighed.

The solubility corresponds to the content of soluble dry matter, expressed as % by weight relative to the weight of the sample. The solubility is calculated with the following formula:

$$\% solubility = \frac{( m 1 - m 2 ) \times ( 200 + P )}{P 1 \times P} \times 100 \qquad [ Math . 1 ]$$

where:
P=weight, in g, of the sample=5 g
m1=weight, in g, of the crystallizing dish after drying
m2=weight, in g, of the empty crystallizing dish
P1=weight, in g, of the sample collected=25 g

Obtaining a pea isolate having a solubility in water at pH 7 of less than 30% is made possible by any method resulting in such a protein. Mention may be made, for pea protein, of patent EP2911524. Chemical and/or thermal denaturation of a protein can also be envisaged.

It is quite unusual for a person skilled in the art of extrusion to have thought of using such a poorly soluble pea isolate for extrusion. It will be noted that in patent application WO2017129921 the use of NUTRALYS® BF (whose solubility at pH 7 and 20° C. is less than 30%) is described as to be avoided in extrusion. Likewise, in application WO2020123585, the use of a NUTRALYS® BF in extrusion to produce dry textures to produce meat analogs does not result in good fibration.

Preferably, the pea protein isolate, having a solubility in water at pH 7 and 20° C. of less than 30%, is characterized in that its water retention capacity is less than 4 grams per gram of material rich in proteins.

The water retention capacity is determined very simply by double weighing. 10 grams of dry weight of protein composition in powder form is taken, which is placed in excess water for 30 minutes. The whole is dried so as to evaporate the water completely (until no significant evolution of the mass of the product is observed). The remaining mass of product is then weighed. The water adsorption capacity is expressed in g of water adsorbed per gram of initial dry product.

In a preferred embodiment, the method for producing the pea isolate whose solubility at pH 7 in water at 20° C. is less than 30% comprises the following steps:
a) using pea seeds or flour;
b) milling and making an aqueous suspension;
c) separating out insoluble fractions using centrifugal force;
d) protein coagulation at isoelectric pH, optionally with the aid of heating;
e) recovery of protein floc,
f) neutralizing floc at pH 7 with lime
g) heat treatment
h) drying

The preferred method thus starts with a step a) of providing pea seeds or flour.

The seeds used in step a may have been previously subjected to steps that are well known to those skilled in the art, such as especially cleaning (removal of undesired particles such as stones, dead insects, soil residues, etc.) or even the removal of the external fibers of the peas (external cellulose hull) through a well-known step referred to as “dehulling”.

Treatments for improving the organoleptic properties of the isolate, such as dry heating (or roasting) or wet bleaching, are also possible. For bleaching, the temperature is preferentially between 70° C.±2° C. and 80° C.±2° C. and the pH is adjusted to a value between 8±0.5 and 10±0.5, preferentially to 9±0.5. These conditions are maintained for 2 to 4 min, preferentially for 3 min. These treatments are in no way intended to cause the drying of the material, but rather to inhibit the various enzymes such as lipoxygenases.

The method according to the invention comprises a step b) of milling the flour and/or seeds and producing an aqueous suspension.

This milling step is necessary for the seed and optional for the flour.

If the seeds are already in the presence of water, the water is retained but may also be renewed, and the seeds are directly milled. If the seeds are dry, a meal is first produced, and it is then suspended in water.

The milling is performed by any type of suitable technology known to those skilled in the art, such as with ball mills, conical mills, helical mills, jet mills or rotor/rotor systems.

During milling, water may be added in a continuous or discontinuous manner, at the start, during or at the end of milling, so as to produce at the end of the step an aqueous suspension of milled peas with between 15% and 25% by weight of solids (SC), preferentially 20% by weight of SC, relative to the weight of said suspension.

At the end of milling, the pH can be checked. Preferably, the pH of the aqueous suspension of milled peas at the end of step b) is adjusted to a value ranging from 8±0.5 and 10±0.5, preferentially the pH is adjusted to 9±0.5. The pH may be adjusted by adding acid and/or base, for example sodium hydroxide or hydrochloric acid.

The preferred method then consists of a step c) of separating out the insoluble fractions using a centrifugal force. These fractions consist mainly of starch and of polysaccharides called “internal fibers”. The proteins soluble in the supernatant are thus concentrated.

The preferred method comprises a step d) of coagulating the proteins at isoelectrical pH, optionally with heating of the protein solution.

If heating is applied in addition to coagulation at the isoelectric pH, it will preferentially be applied with a temperature ranging from 55° C.±2° C. to 75° C.±2° C., preferentially from 60° C. to 70° C.±2° C., for a time ranging from 1 min to 5 min, preferentially from 2 min to 4 min, even more preferentially 3 min.

The purpose of this step d) here is to separate the pea proteins of interest from the other constituents of the supernatant from step c). Such a process example is described, for instance, in EP1400537 of the Applicant, from paragraph 127 to paragraph 143. It is essential to better control the time/temperature in order not to denature the protein.

The following step e) consists of collecting the coagulated protein floc by centrifugation. The solid fractions with concentrated proteins are thus separated from the liquid fractions with concentrated sugars and salts

In a step f), the floc is resuspended in water and its pH is adjusted to a value ranging from 6±0.5 to 9±0.5, preferentially from 6.5 to 7.5, more preferentially 7. The solids content is adjusted to a rate ranging from 10% to 20%, preferentially 15% by weight of solids relative to the weight of said suspension. The pH is adjusted using calcium hydroxide, also known as lime.

In step g), a heat treatment is applied

Final step h) consists in drying, preferentially by atomization.

Preferably, a plant fiber, preferentially a legume fiber, may be added. “Leguminous fiber” is understood to mean any compositions comprising polysaccharides that are relatively indigestible or indigestible by the human digestive system, extracted from leguminous plants. Such fibers are extracted using any method that is well known to the person skilled in the art. A commercial example of such a fiber is for example Pea Fiber I 50M (containing, with respect to the total weight of product, 50% by weight minimum of internal pea fibers, 10% by maximum weight of pea proteins and about 35% by weight of pea starch) from the company Roquette.

The legume fiber is preferably selected from the list made up of faba bean fiber and pea fiber. Pea fiber is particularly preferred.

The mixture fed into the extruder can essentially consist of legume proteins and legume fibers. The term “essentially consist of” means that the powder can comprise impurities associated with the method for producing the proteins and the fibers, for example, traces of starch.

The dry weight ratio between proteins and fibers is advantageously from 70/30 to 90/10, preferentially from 75/25 to 85/15.

The mixing can be carried out upstream or even directly when being fed into the extruder. During this mixing, additives can be added that are well known to the person skilled in the art, such as flavorings or even dyes.

In an alternative preferred embodiment, a plant fiber, preferentially a legume fiber, may be added. The addition of such a quantity of proteins makes it possible both to increase the quantity of extruded protein but can also improve the nutritional quality. On that matter, the measured addition of another protein source to that of the legume protein composition will be carried out without drying in order to improve the PDCAAS of the textured protein produced.

PDCAAS (Protein Digestibility Corrected Amino Acid Score) is an index that is used to evaluate the quality of the proteins as a function of the human amino acid and protein digestibility requirements. The method for calculating PDCAAS is based on comparing a standard amino acid profile having the best possible score (1 or 100%), with the amino acid profile of the food being studied. The PDCAAS is evaluated on a scale of 0 to 1 (1 designating the best quality and 0 the least good).

For any embodiment of the invention, well-known food processing components can be added, for example water, dyes, flavorings, gelling agents, stabilizers, and antioxidants.

In the present invention, “water” is understood to mean water that can be drunk or used for domestic and industrial purposes without posing health risks. Preferably, it will be understood that this water has a sulfate content of less than 250 mg/l, a chloride content of less than 200 mg/l, a potassium content of less than 12 mg/l, a pH ranging from 6.5 to 9 and a total hardness (TH, namely the hardness of the water, corresponding to the measurement of the calcium and magnesium ions content in water) of more than 15 French degrees. In other words, drinking water must not have less than 60 mg/l of calcium or 36 mg/l of magnesium.

“Flavorings” is understood in the present invention to mean any chemical compound making it possible to modify the perception of taste and smell, which together form what is known as “flavor”. European legislation, as defined by Regulation 1334/20082, understands flavorings to be “products not intended to be consumed as such, which are added to food in order to impart or modify odor and/or taste” (Article 3.a of Regulation EC 1334/2008).

Flavorings are derived from or consist of the following components: flavoring substances, flavoring preparations, smoke flavorings, thermal process flavorings, flavor precursors and other flavorings.

In the context of the present invention, flavoring is preferentially understood to mean a flavoring substance. A flavoring substance is a “defined chemical substance with flavoring properties” (definition in Article 3.b of Regulation EC 1334/2008).

A natural flavoring substance is “obtained by appropriate physical, enzymatic or microbiological processes, from material of vegetable, animal or microbiological origin either in the raw state or after processing for human consumption by one or more of the traditional food preparation processes listed in Annex II of Regulation EC 1334/2008” (Article 3.c of Regulation EC 1334/2008).

Natural flavoring substances correspond to substances that are naturally present and have been identified in nature. The flavoring substances can also be derived from natural sources other than the “raw” natural source, it is then a matter of synthesizing the molecule and reproducing it. Other molecules, that have not been identified in nature, can also have a more powerful taste than natural molecules.

A particular case of flavoring substance will be the generating of compounds resulting from the Maillard reaction. This chemical reaction between reducing compounds such as sugars and amine compounds such as proteins generates colored and odorizing compounds.

“Dyes” means any type of compound, or even combination of compounds, having the ability to modify the color of another compound (or even mixture of compounds) due to its introduction.

The dye can itself provide its functionality. These dyes will be of any type such as natural dyes (such as the concentrates and/or extracts of fruits and vegetables) or artificial dyes. In the context of our invention, particularly interesting dyes can be selected, including but not limited to: beet betaine, tomato lycopene, pepper extract (paprika), caramel. Indeed, these red and/or brown dyes make it possible to quite easily imitate the color of red meat.

The coloration can also be generated during extrusion by chemical reaction with a protein compound. Here again, the Maillard reaction can be cited again, as well as the use of iron salts.

The protein content of the mixture feeding the method according to the invention advantageously ranges from 60% to 80%, preferentially from 70% to 80% by weight relative to the total dry matter. Any method well known to the person skilled in the art can be used to analyze this protein content. Preferably, the total nitrogen amount will be assayed and this content will be multiplied by the coefficient 6.25. This method is particularly known and used for plant proteins.

The second step of the method according to the invention consists in texturing by extrusion cooking of said mixture obtained in step 1. During this second step, this mixture will then be textured, which is the same as saying that the proteins will undergo thermal destructuring and reorganization in order to form fibers with continuous elongation in straight, parallel lines, simulating the fibers present in meats. Any method well known to the person skilled in the art will be suitable, in particular extrusion.

“Textured” or “texturing” in the present application is understood to mean any physical and/or chemical process that aims to modify a composition comprising proteins in order to give it a specific ordered structure. Within the scope of the invention, texturing proteins aims to give the appearance of a fiber, such as those present in animal meats.

Extrusion consists in forcing a product to flow through a small hole, the die, under the action of high pressures and shearing forces, using the rotation of one or two Archimedes screws. The resulting heating causes cooking and/or denaturing of the product, hence the term sometimes used, “extrusion cooking”, then expansion by evaporation of the water at the die outlet. This technique makes it possible to develop products which are widely varied in their composition, their structure (expanded and alveolar form of the product), and their functional and nutritional properties (denaturing of anti-nutritional or toxic factors, sterilization of food, for example). Processing of proteins often leads to structural modifications which are reflected by obtaining products with a fibrous appearance, simulating animal meat fibers.

In general, step 2 can be carried out with a water/dry matter mass ratio in the extruder that can range from 15% to 70%.

More preferentially, the water/dry matter mass ratio in the extruder will be from 40% to 70%, even more preferentially from 50% to 65%. This ratio is obtained by analyzing the mixture entering the extruder.

Without being bound by any theory, it is well known to a person skilled in the art of extrusion cooking that it is this preferential ratio that will allow the required quality of the final product to be obtained, in terms of texture, organoleptic quality, or appearance. The values of this ratio therefore will potentially be 40, 41, 42, 43, 44, 45, 46, 47, 48, 49, 50, 51, 52, 53, 54, 55, 56, 57, 58, 59, 60, 61, 62, 63, 64, 65, 66, 67, 68, 69 or 70%.

Preferably, the wet extrusion cooking of step 2 is carried out by extrusion cooking in an extruder, preferentially a twin-screw extruder, characterized by a length/diameter ratio ranging from 35 to 65, preferentially from 40 to 65, even more preferentially 60, and equipped with a succession of conveying elements, kneading elements, and reverse pitch elements which will be selected by a person skilled in the art to ensure good extrusion, based on his conventional knowledge of the field.

The length to diameter ratio is a conventional parameter in extrusion cooking. This ratio therefore can be 35, 36, 37, 38, 39, 40, 41, 42, 43, 44, 45, 46, 47, 48, 49, 50, 51, 52, 53, 54, 55, 56, 57, 58, 59, 60, 61, 62, 63, 64 or 65.

The various elements are the feeding elements intended for feeding the product into the die without modifying the product, the kneading elements intended for mixing the product and the reverse pitch elements intended for applying a force to the product to cause it to advance in the opposite direction and thus cause mixing and shearing.

Even more preferably, a specific power ranging from 10 tom 25 kWh/kg is applied to the powder mixture, by regulating the pressure at the outlet in a range ranging from 10 to 25 bars, preferentially from 12 to 16 bars.

Even more preferably, the outlet of the twin-screw extruder consists of an outlet die with orifices opening onto a cutter.

Preferably, the extruder outlet consists of a cooled die in order to limit the expansion. The extruded wet strip will be cut, stored and/or implemented in the form of meat or fish analogs.

To specify this embodiment, the die described at the preceding point may consist of one or more modules equipped with cooling circuits. The cooling of the die is in the majority of cases carried out in the direction opposite the flow of material coming from the extruder. Temperature control can be carried out using thermoregulators by applying temperatures ranging from 10 to 95° C.

In all the embodiments described, it will be possible to carry out post-production steps such as, in a non-exhaustive manner, grinding, marinading, drying, freezing, deep-freezing, brining, and adsorption of dyes and/or flavorings.

In a preferred embodiment, a marinade of dyes and flavorings will be applied in order to impregnate the composition of textured legume proteins followed by drying. This succession of steps can thus be used to obtain a plant “jerky”, a North American specialty of dried, salted beef, cut into thin strips.

In an even more preferred embodiment, the textured plant protein composition will be ground, added to different compounds including flavorings and dyes, then molded into a patty shape.

The present invention also relates to the composition comprising

textured plant proteins capable of being obtained by the method according to the invention.

In a particular embodiment, the composition according to the invention has a protein content ranging from 60% to 80%, preferentially from 70% to 80% by dry weight relative to the total weight of dry matter of the composition.

Finally, the present invention relates to the use of the composition of textured plant proteins according to the invention or able to be obtained by the method according to the invention in industrial applications such as, for example, the human and animal food industry, industrial pharmaceuticals or cosmetics.

The invention will be of particular interest in the field of analogs of meat, fish, sauces, soups.

More preferably, a particular application relates to the use of the composition according to the invention to manufacture a meat analogs, in particular of ground meat, but also analogs of bolognese sauce, steak for hamburger, meat for tacos and pita, “chili sin carne.”

In pizzas, the texture composition according to the invention will be of particular interest for being sprinkled on top of said pizza (as a “topping”).

The human and animal food industry is also understood to include industrial confectionery (for example, chocolate, caramel, jelly sweets), bakery products (for example, bread, brioches, muffins), the meat and fish analog industry (for example, analogs of sausages, hamburgers, fish nuggets, chicken nuggets), sauces (for example, bolognese, mayonnaise), analogs of products derived from milk (for example, plant cheese, plant milk), beverages (for example, high protein beverages, powdered beverages to be reconstituted).

According to a particular embodiment, the present invention also relates to the use of the textured plant proteins composition according to the invention or capable of being obtained by the method according to the invention in the production of textured proteins by extrusion intended for the fields of animal and/or human food.

The invention will be better understood upon reading the following non-limiting examples.

### BRIEF DESCRIPTION OF THE DRAWINGS

FIG. 1 shows an image corresponding to a microscopy grade of 5;

FIG. 2 shows an image corresponding to a microscopy grade of 0.5;

FIG. 3 shows the significance of FT and FL in the context of the anisotropy test;

FIG. 4 shows an example of a “brittle” structure;

### EXAMPLES

### Example 1: Production of a Composition of Textured Legume Proteins in a Wet Process Outside of the Invention

A number of powder mixes are produced, the relative compositions of which are given in the table below.

The following raw materials, all produced by ROQUETTE, will be used to manufacture these products:
NUTRALYS® F85M (pea protein isolate with a solubility of over 30% at pH7 at 20° C., here 47%)
NUTRALYS® B85F (pea protein isolate with a solubility of less than 30% at pH7 at 20° C., here 17%)
NUTRALYS® RICE I-850 XF EXP (rice protein isolate with a solubility of less than 30% at pH7 at 20° C., here 15%)
Pea Fiber 150M (internal pea protein fiber)
Potato starch (native potato starch)

This mixture is introduced by gravity into a LEISTRITZ ZSE 27MAXX extruder from Leistriz of motor power equal to 33.8 KW and whose maximum achievable rotational speed is 1200 rpm.

The mixture is introduced with a regulated flow rate of 12 to 14 kg/h. Between 14 and 16 kg/h of water is also introduced. The humidity in the extruder is thus regulated around 55%+/−2%.

The extrusion screw is composed of conveying elements, kneading elements and reverse pitch elements organized according to the following profile detailed in Table 1 below:

TABLE 1

| | Name of | Type of |
|---|---|---|
| Elements | screw elements | screw elements |
| 1 | GFA-2-20-30 (start) | conveying |
| 2 | GFF-2-40-30-A | conveying |
| 3 | GFF-2-40-30-M | conveying |
| 4 | GFF-2-40-30-M | conveying |
| 5 | GFF-2-40-30-M | conveying |
| 6 | GFF-2-40-30-M | conveying |
| 7 | GFF-2-40-30-M | conveying |
| 8 | GFF-2-40-30-E | conveying |
| 9 | GFA-2-40-30 | conveying |
| 10 | GFA-2-40-30 | conveying |
| 11 | GFA-2-40-30 | conveying |
| 12 | GFA-2-40-30 | conveying |
| 13 | GFA-2-40-30 | conveying |
| 14 | GFA-2-40-30 | conveying |
| 15 | GFA-2-40-30 | conveying |
| 16 | GFA-2-40-30 | conveying |
| 17 | GFA-2-30-30 | conveying |
| 18 | GFA-2-30-30 | conveying |
| 19 | GFA-2-30-30 | conveying |
| 20 | GFA-2-40-30 | conveying |
| 21 | GFA-2-40-30 | conveying |
| 22 | GFA-2-40-30 | conveying |
| 23 | GFA-2-30-30 | conveying |
| 24 | KB-4-2-15-90 | kneading |
| 25 | KB-4-2-15-90 | kneading |
| 26 | GFA-2-40-30 | conveying |
| 27 | GFA-2-30-30 | conveying |
| 28 | GFA-2-30-30 | conveying |
| 29 | GFA-2-30-30 | conveying |
| 30 | GFA-2-20-30 | conveying |
| 31 | KB-4-2-15-30 | kneading |
| 32 | KB-4-2-15-90 | kneading |
| 33 | GFA-2-20-30-L | Reverse |
| 34 | GFA-2-40-30 | conveying |
| 35 | GFA-2-40-30 | conveying |
| 36 | GFA-2-30-30 | conveying |
| 37 | KB-4-2-15-90 | kneading |
| 38 | KB-4-2-15-90 | kneading |
| 39 | GFA-2-40-30 | conveying |
| 40 | GFA-2-40-30 | conveying |
| 41 | GFA-2-30-30 | conveying |
| 42 | GFA-2-20-30 | conveying |
| 43 | KB-4-2-15-90 | kneading |
| 44 | KB-4-2-15-90 | kneading |
| 45 | GFA-2-20-30-L | Reverse |
| 46 | GFA-2-20-30 | conveying |
| 47 | GFA-2-40-30 | conveying |
| 48 | GFA-2-40-30 | conveying |
| 49 | GFA-2-20-30 | conveying |
| 50 | KB-4-2-15-30 | kneading |
| 51 | KB-4-2-15-90 | kneading |
| 52 | GFA-2-40-30 | conveying |
| 53 | GFA-2-30-30 | conveying |
| 54 | GFA-2-30-30 | conveying |
| 55 | GFA-2-20-30 | conveying |
| 56 | KB-4-2-15-90 | kneading |
| 57 | KB-4-2-15-90 | kneading |
| 58 | GFA-2-30-30 | conveying |
| 59 | GFA-2-20-30 | conveying |
| 60 | GFA-2-20-30 | conveying |
| 61 | GFA-2-20-30 | conveying |

This extrusion screw is rotated at a speed equal to 350 rpm and sends the mixture into a die. A temperature profile detailed below in Table 2 (in degrees Celsius) is employed, using 15 tubes located around the extruder and which can be heated:

TABLE 2

| | Z15 | Z14 | Z13 | Z12 | Z11 | Z10 | Z9 | Z8 | Z7 | Z6 | Z5 | Z4 | Z3 | Z2 | Z1 |
|---|---|---|---|---|---|---|---|---|---|---|---|---|---|---|---|
| Temp. | 90 | 120 | 120 | 130 | 115 | 115 | 110 | 90 | 60 | 60 | 60 | 60 | 35 | 35 | x |
| profile | | | | | | | | | | | | | | | |

The product is directed at the outlet to a thermally controlled die, FDK750 model from the brand Coperion, comprising two modules with a length of 80 cm and a passage cross-section 50 mmx 15 mm, the 2^{nd} module of which being thermally controlled to 30° C.

The textured protein thus produced is cut at the outlet of the die into 10 cm strips.

The torque is raised during extrusion (and the average torque and its standard deviation are calculated) and the SME (Specific Mechanical Energy) is calculated using the formula below (expressed in kWh/Kg):

$$[ Math . 1 ]$$

$$SME ( kWh / kg ) = \frac{\begin{matrix}yield coeff \times motor P max ( kW ) \times \\ torque ( \% ) \times screw speed used ( rpm )\end{matrix}}{max screw speed ( rpm ) \times total flow rate ( kg / h )} .$$

TABLE 3

| Data | Origin | Value |
|---|---|---|
| Yield coeff | Equipment technical data | 0.97 |
| Motor P max (kW) | Equipment technical data | 33.8 |
| Max screw speed | Equipment technical data | 1200 |
| (rpm) | | |
| Torque (%) | Read during the tests | See summary table |
| Screw speed used | Test variable | 350 (or see |
| (rpm) | | summary table) |
| Total flow rate | Test variable | See summary table |

The extrusion strips obtained are evaluated in two ways

The anisotropy index is first measured. Samples of the extrusion strips after production are taken (cut (40×40 mm), frozen and stored at −20° C. until analysis. After thawing overnight at room temperature, the cutting resistance of the samples was assessed using a TA.XT plus texture analyzer (Stable Micro Systems, UK), with a flat knife blade (A/LKB-F) and using a 5 kg load cell 60 mm wide and 1 mm thick. The analysis parameters are: pre-test speed=2 mm/s, test speed=2 mm/s, post-test speed=10 mm/s, strain=75%

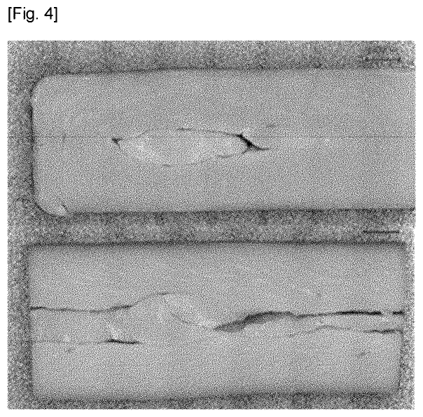

The cutting resistance of the samples is measured in the longitudinal direction (FL) and in the transverse direction (FT) with respect to the direction of flow in the cooling matrix channel. (cf. FIG. 3)

The anisotropy index is equal to FT/FL

Microscopic analysis is also carried out.

As with the anisotropy test, samples of the extrusion strips after production are taken (cut (40×40 mm), frozen and stored at −20° C. until analysis. After thawing overnight at room temperature, the samples are cut in two ways (transverse and longitudinal), to a size of about 40*10*4 mm. Samples are observed after 10 minutes of air-drying. Image capture is performed using the Keyence VHX-5000 microscope, equipped with a VH-Z20R/W/T lens set to X30, in “3D image stitching” mode.

The observation range is defined using the “Define range” option, so that the sample occupies the entire width of the image acquisition range.

The min and max limits of the Z axis can also be set prior to acquisition via the “Z parameters” option. To do this, lower the lens until the image is blurred: this is the minimum limit. Then raise the lens, go through the Z-axis setting where sharpness is perfect, and raise again until the image is blurred again: this is the maximum limit.

If the sample is not of uniform thickness, check in the same way at the highest and lowest points of the sample.

Acquisition speed is checked in “auto” mode.

Generally speaking, the various criteria observed on the strips are: fibration (presence of fibers, elongation), structure (presence of porosity, compact, dense and homogeneous strip).

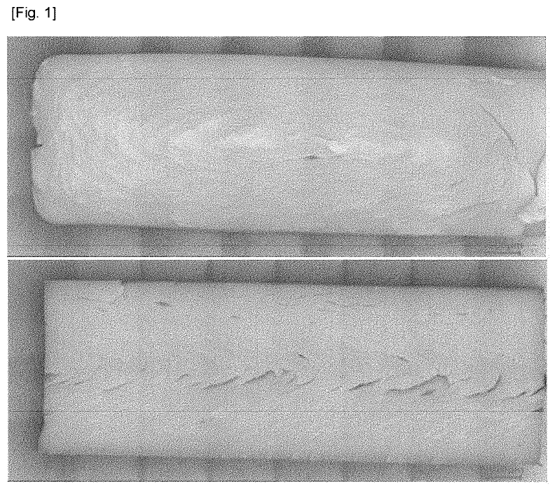

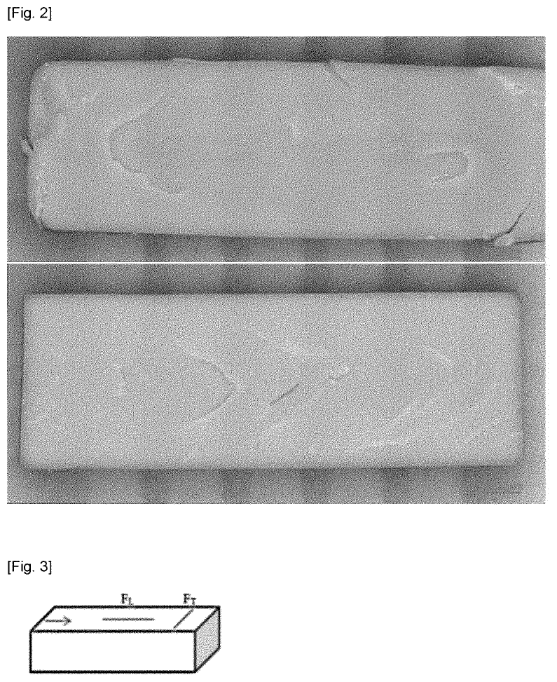

A score ranging from 0 to 5 is given to the sample according to the aspect of the fibration (see FIGS. 1 and 2 for examples of scores of 0.5 and 5).

Table 4 below summarizes the various tests carried out as well as the results obtained.

TABLE 4

| Ref. | Test 1 | Test 2 | Test 3 | Test 4 | Test 5 | Test 6 | Test 7 | Test 8 |
|---|---|---|---|---|---|---|---|---|
| Nutralys ® F85M | 100 | 90 | 90 | 70 | 70 | 92 | 82 | 62 |
| Nutralys ® BF | 0 | 10 | 0 | 0 | 30 | 0 | 10 | 30 |
| Rice protein isolate | 0 | 0 | 10 | 30 | 0 | 0 | 0 | 0 |
| Native potato starch | 0 | 0 | 0 | 0 | 0 | 3 | 3 | 3 |
| I50M pea fiber | 0 | 0 | 0 | 0 | 0 | 5 | 5 | 5 |
| Longitudinal cutting | 7870 | 8900 | 7630 | 7120 | 7390 | 7330 | 7550 | 6650 |
| force FL (in g) | | | | | | | | |
| Transverse cutting | 7500 | 6330 | 6040 | 6410 | 5800 | 5900 | 5990 | 6060 |
| force FT (in g) | | | | | | | | |
| FT/FL | 0.95 | 0.71 | 0.79 | 0.90 | 0.78 | 0.80 | 0.79 | 0.91 |
| Microscopic | 4 | 5 | 3 | 0.5 | 5 | 1 | 5 | 1 |
| observation note | | | | | | | | |
| Comments | Good | Excellent | Compact | Very | Good | Very | Good | Very |
| | fibration. | fibration | | compact | fibration | compact | fibration | compact |
| | Atypical | | | | | | | |
| | structure | | | | | | | |

The first control (Test 1), whose powder mixture contains only a pea isolate whose solubility at pH 7 and 20° C. is greater than 30% (Nutralys® F85M), is Test 1. Fibration is quite good (score 4) but the structure is considered atypical in that it appears fragile. FIG. 4 shows a structure considered to be “fragile”: the fibration is clearly visible, but there are also splits within the strip, causing it to separate into several pieces. When handling the strip, this separation may be unwanted.

By adding 10% of a pea isolate whose solubility at pH 7 and 20° C. is less than 30% (test 2), fibration is excellent (score 5) and the anisotropy index (FT/) around 30%. As is well known from the literature, this demonstrates better differentiation of fibration in the longitudinal versus transverse direction, which is closer to meat. By increasing to 30% (Test 5), fibration remains good but the anisotropy index rises slightly.

By adding 10% of a rice isolate whose solubility at pH 7 and 20° C. is less than 30% (test 3), fibration is less good than the control (score 3) and the anisotropy index (FT/FL) remains high. Moving up to 30% (Test 4), the results are even worse in terms of fibration and anisotropy index. This demonstrates the importance of the pea botanical origin of the isolate, whose solubility at pH 7 and 20° C. is less than 30%, to obtain the desired effect.

The second control, with a slightly more elaborate powder mix containing 5% fiber and 3% starch, is test 6. The addition of these compounds leads to a collapse in fibration quality (score 1) and anisotropy index (0.95 to 0.80). Test 7 shows once again that replacing 10% of the protein with a pea isolate whose solubility at pH 7 and 20° C. is less than 30% restores fibration quality (score 5) and a better anisotropy index. Conversely, a 30% replacement is ineffective.

1. A method for producing a plant protein composition comprising the following steps:
1) Providing a mixture comprising:
plant proteins, preferentially legume proteins, more preferentially pea proteins,
and a pea protein isolate, said isolate having a solubility in water at pH 7 and 20° C. of less than 30%,
said mixture having a respective dry weight ratio of the plant protein to pea protein isolate ranging from 70/30 to 95/5, preferentially from 75/25 to 95/5, more preferentially from 80/20 to 95/5, even more preferentially from 85/15 to 95/5;
2) Texturizing said mixture obtained in step 1 by wet extrusion cooking.

2. The method according to claim 1, wherein the plant proteins are selected from the list containing pea and faba bean, even more preferentially pea.

3. The method according to one of claims 1 to 2, wherein the wet extrusion cooking of step 2 is carried out in a twin-screw extruder.

4. A composition comprising textured plant proteins capable of being obtained by a production method according to one of claims 1 to 3.

5. The composition according to claim 4, having a protein content ranging from 60% to 80%, preferentially from 70% to 80% by dry weight relative to the total weight of dry matter of the composition.

6. A use of the textured plant protein composition according to claim 4 or 5 or capable of being obtained by a production method according to one of claims 1 to 3 in industrial applications such as the human and animal food industry, industrial pharmaceuticals or cosmetics.

7. The use according to claim 6, wherein the industrial application is the production of meat analogs, fish analogs.

8. The use according to claim 6, wherein the industrial application is the production of sauces, soups.

9. The use according to claim 6, wherein the industrial application is the production of proteins textured by extrusion cooking for the fields of animal and/or human food.
